(19) United States
(12) Patent Application Publication
(10) Pub. No.: US 2024/0191731 A1
(43) Pub. Date: Jun. 13, 2024

(54) HYDRAULIC CYLINDER AND RESTRAINT SYSTEM

(71) Applicant: HAWE Hydraulik SE, Aschheim (DE)

(72) Inventors: Christian HART, Aschheim (DE); Sven MUELLER, Aschheim (DE); Matthias KUBE, Aschheim (DE)

(21) Appl. No.: 18/523,303

(22) Filed: Nov. 29, 2023

(30) Foreign Application Priority Data
Dec. 12, 2022 (DE) 10 2022 213 458.3

(51) Int. Cl. F15B 15/14; F15B 1/04

(52) U.S. Cl. CPC F15B 15/1428; F15B 1/04

(57) ABSTRACT

A hydraulic cylinder for a restraint system includes an outer housing, an inner housing, a pressure accumulator and a shut-off valve switchable between a release position and a shut-off position. The inner housing is disposed inside the outer housing and has a piston, a first working chamber and a second working chamber, which is separated from the first working chamber by the piston. The first working chamber is connected to the accumulator via a first line arrangement, and the second working chamber is connected to the accumulator via a second line arrangement. The pressure accumulator comprises a storage space for hydraulic fluid. The shut-off valve is disposed in the second line arrangement and blocks the second line arrangement in the shut-off position. The pressure accumulator is disposed between the outer housing and the inner housing.

### CROSS REFERENCE TO RELATED APPLICATION

This application claims priority from German Patent Application No. 10 2022 213 458.3, filed on Dec. 12, 2022, the entire content of which is incorporated herein by reference in their entirety.

### FIELD OF THE INVENTION

The present invention relates to a hydraulic cylinder for a restraint system, and to a restraint system comprising such a hydraulic cylinder.

### BACKGROUND OF THE INVENTION

Such hydraulic cylinders for restraint systems are known from the prior art and are regularly used in amusement rides, for example in roller coasters. These restraint systems serve to fix a passenger in a passenger seat and to prevent the passenger from falling out during the ride. For this purpose, a bar or the like is usually pulled manually against the passenger's body until the passenger is adequately secured in the passenger restraint.

For this purpose, the hydraulic cylinders are configured in such a way that they can be switched between a freely movable state and a state locked in at least one direction. The hydraulic cylinders used for this purpose regularly have a cylinder housing, a piston movably disposed in the cylinder housing, a first working chamber and a second working chamber separated from the first working chamber by the piston. In addition, the hydraulic cylinders are usually part of a hydraulic system with a pressure accumulator and a shut-off valve that can be switched between a release position and a shut-off position. Such a hydraulic system is known, for example, from DE 10 2019 216 083 A1.

The first working chamber and the second working chamber are connected via a line arrangement to the pressure accumulator, which includes a storage space for hydraulic fluid, and the shut-off valve is disposed in the line arrangement so as to shut off the line arrangement and prevent hydraulic fluid from flowing out of the second working chamber via line arrangement. This ensures that passengers on the amusement ride cannot open the restraint system during the ride, but can adjust it tighter for better restraint performance if needed.

As safety-relevant components, these hydraulic systems are regularly checked, maintained and replaced if necessary. The problem here is that the hydraulic systems can be difficult to access in the limited installation space of the ride, and disassembly for a technician is made even more difficult by the weight of the hydraulic system. Furthermore, most of the known hydraulic systems also have protruding components that could be damaged by external forces.

Therefore, it is the object of the present invention to provide a hydraulic cylinder for a restraint system that is lightweight, compact, and easily replaceable. It is further the object of the present invention to disclose a restraint system having such a hydraulic cylinder.

The solution of the problem is achieved with a hydraulic cylinder according to embodiments disclosed herein. Preferable embodiments are described in the dependent claims.

According to the invention, a hydraulic cylinder comprising an outer housing, an inner housing, a pressure accumulator and a shut-off valve is provided. The shut-off valve is switchable between a release position and a shut-off position. According to the invention, the inner housing is disposed inside the outer housing and the inner housing comprises a first working chamber and a second working chamber, which is separated from the first working chamber by a piston disposed axially movably in the inner housing. The first working chamber is connected to the pressure accumulator via a first line arrangement, and the second working chamber is connected to the pressure accumulator via a second line arrangement. The pressure accumulator comprises a storage space for hydraulic fluid. The shut-off valve is disposed in the second line arrangement and blocks the second line arrangement in the shut-off position, so that hydraulic fluid is prevented from flowing out of the second working chamber. According to the invention, the pressure accumulator is disposed between the outer housing and the inner housing.

The shut-off valve, which is configured, for example, as a mechanically, electrically or electromagnetically actuated check valve, can be used to block the outflow of hydraulic fluid from the second working chamber. Depending on the requirement, the shut-off valve is in the shut-off position or in the release position in the actuated state. The shut-off valve is configured in such a way that the inflow of hydraulic fluid into the second working chamber is always possible. For example, in a restraint system of an amusement ride, the passenger can be held securely in the passenger seat because the restraint system does not open. At the same time, however, the restraint system can be set tighter for a better restraint effect even when the shut-off valve is closed. Due to the arrangement of the pressure accumulator inside the outer housing, the hydraulic cylinder represents a hydraulically closed system.

This provides a hydraulic cylinder that has a compact design without protruding components due to the pressure accumulator being disposed inside the outer housing, which makes it easy to replace the hydraulic cylinder. In addition, the weight is reduced by eliminating additional add-on parts, such as a support element for the pressure accumulator.

Preferably, the storage space is formed at least by the inner housing and an at least partially elastic membrane. The at least partially elastic membrane allows the volume of the storage space to change as required and depending on the position of the piston. This can compensate for the different volume of the working chambers when the piston moves in or out. The membrane can be made of an elastomer or other material, for example, as long as the material is impermeable to air and hydraulic fluid.

Preferably, the membrane is arranged around the inner housing. In other words, the membrane surrounds the inner housing in a radial direction so that the inner housing is arranged radially inside the membrane. By arranging the membrane around the inner housing, the space within the outer housing can be better utilized. For example, the membrane can be arranged in a tubular shape in the axial direction of the hydraulic cylinder.

Alternatively or complementarily, the membrane has at least one elastic portion and at least one fixed portion. The elastic portion makes it possible to change the volume of the storage space. The fixed portion prevents the membrane from slipping, for example, as a result of expansion of the elastic portion.

Furthermore, it is preferable that the hydraulic cylinder comprises at least one retaining member, wherein the fixed portion is disposed between a radial surface of the at least one retaining member and the outer housing. By means of the retaining member, the fixed portion of the membrane is retained on the outer housing in such a way that the transition between the retaining member and the membrane is impermeable to air and hydraulic fluid. The retaining member can also be configured, for example, to additionally rest against the inner housing.

Preferably, the storage space is additionally formed by an axial surface of the at least one retaining member. By using the at least one retaining member as an additional boundary of the storage space, the storage space can be limited by components already present, whereby no additional weight is added by further components separately provided for this purpose.

Furthermore, it is preferable that the at least one retaining member is arranged around the inner housing. Such an arrangement of the retaining member allows, for example, a membrane arranged around the inner housing to be held securely.

Preferably, the hydraulic cylinder has two retaining members disposed at both axial ends of the at least partially elastic membrane. This ensures that the elastic membrane is held in position relative to the inner housing.

Preferably, a preloading element preloads the membrane. This provides a pressure acting in one direction in the hydraulic system. The pressure ensures that there is always enough hydraulic fluid in the first line arrangement and the second line arrangement when the hydraulic cylinder is extended or retracted.

Preferably, the preloading element is disposed between the membrane and the outer housing. This allows the membrane to be preloaded in the direction of the inner housing and thus provide the necessary pressure in the hydraulic system.

Preferably, the preloading element comprises a spring, a foam, an elastic silicone oil and/or a space filled with compressed air. By selecting the preloading element or a combination thereof, the preload of the membrane and thus the pressure on the hydraulic system can be specifically adjusted.

Furthermore, a separation element is useful, which is disposed in the storage space. The separation element prevents the membrane from contacting the inner housing and causing the membrane to adhere to the inner housing, for example, so that the hydraulic fluid can no longer flow through the storage space. Such adhesion or contact of the membrane could impair the function of the pressure accumulator and is effectively prevented by the separation element. In other words, the separation element ensures that the hydraulic fluid can flow through the storage space at all times.

Preferably, the separation element is arranged around the inner housing. The arrangement around the inner housing effectively prevents the membrane from being applied around the entire inner housing. The separation element can be made of any material that is resistant to hydraulic oil.

The separation element may be a helical spring. As a common element, a helical spring is a cost-effective separation element, for example for round inner housings.

Preferably, the separation element is provided on the inner housing. In other words, the inner housing can have the separation element. By providing the separation element on the inner housing, additional components can be saved. The separation element may be provided, for example, in the form of grooves, projections or a thread on the inner housing. Such grooves can, for example, be made in the surface of the inner housing by turning or milling, projections can be provided by welding, printing or gluing material to the inner housing, and threads can, for example, be cut into a round inner housing.

Preferably, a pressure relief valve is disposed between the first working chamber and the second working chamber. The pressure relief valve prevents damage to the hydraulic system if, for example, a line arrangement is unintentionally blocked or there is an unintentional increase in pressure due to temperature fluctuations. When the opening pressure set on the pressure relief valve is reached, the hydraulic fluid is routed directly from one working chamber to the other working chamber.

Alternatively, it is conceivable that the hydraulic cylinder is configured without a membrane. Air or a gas within the storage space, for example, can then serve as the preloading element, providing the necessary pressure by compression. For such a hydraulic cylinder, it must be ensured that the air or gas does not accumulate between the piston and the shut-off valve, in particular by using the hydraulic cylinder in a purely horizontal position. Furthermore, additional sealing elements impermeable to air and hydraulic fluid must be disposed at suitable points on the hydraulic cylinder, since a sealing function is no longer provided by the then missing membrane.

Furthermore, the solution of the problem is achieved with a restraint system according to claim 15. According to the invention, the restraint system comprises a hydraulic cylinder described above.

Furthermore, use of the hydraulic cylinder according to the invention is also conceivable in other hydraulic systems, for example in (fire) doors or other differently configured joints that need to be held, for example in exoskeletons.

### BRIEF DESCRIPTION OF THE DRAWINGS

FIG. 1 is a hydraulic circuit diagram of the hydraulic cylinder according to the invention;

FIG. 2 is a perspective view of a hydraulic cylinder according to the invention; and

FIG. 3 is an axial section through the hydraulic cylinder shown in FIG. 2.

### DETAILED DESCRIPTION OF THE INVENTION

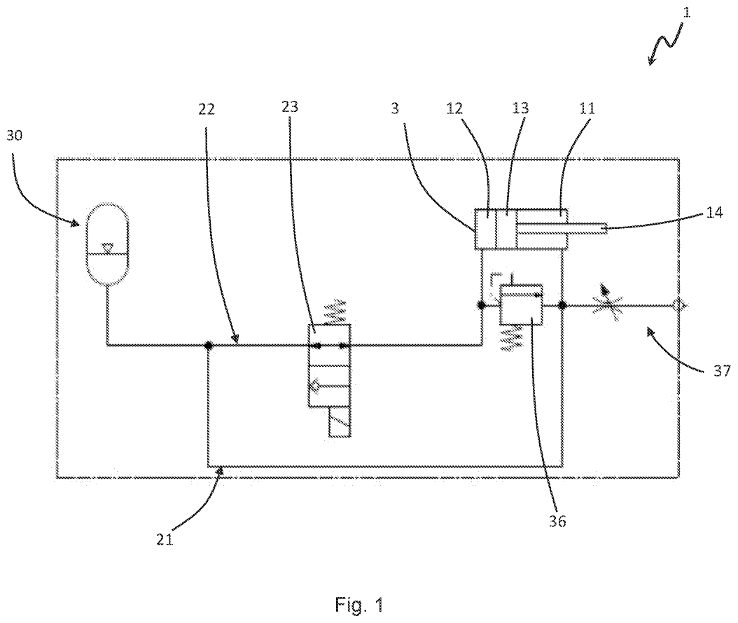

FIG. 1 shows a circuit diagram of a hydraulic circuit of a hydraulic cylinder 1 according to the invention. The hydraulic cylinder 1 comprises an inner housing 3, in which a first working chamber 11 and a second working chamber 12 are disposed. A piston 13 is movably disposed between the working chambers 11, 12, on which a piston rod 14 is provided which extends through the first working chamber 11. The first working chamber 11 is connected to the pressure accumulator 30 via a first line arrangement 21. The second working chamber 12 is connected to the accumulator 30 via a second line arrangement 22. A shut-off valve 23 is disposed in the second line arrangement 22. As shown, the shut-off valve 23 in this embodiment is configured as an electromagnetically actuated check shut-off valve which, in the unactuated release position shown, allows hydraulic fluid flow in both directions of the second line arrangement 22. In the actuated shut-off position of the check valve 23, hydraulic fluid flow through the second line arrangement 22 is blocked by the check function of the check valve 23 in the direction of the pressure accumulator 30, while hydraulic fluid flow through the second line arrangement in the direction of the second working chamber 12 is still possible.

In the exemplary embodiment shown, a pressure relief valve 36 is disposed between the first line arrangement 21 and the second line arrangement 22, which opens when a set pressure is reached within the second line arrangement 22, allowing hydraulic fluid flow from the second line arrangement 22 into the first line arrangement 21.

Furthermore, a closable fill valve 37 is provided through which the hydraulic circuit can be filled with hydraulic fluid via an additional line arrangement.

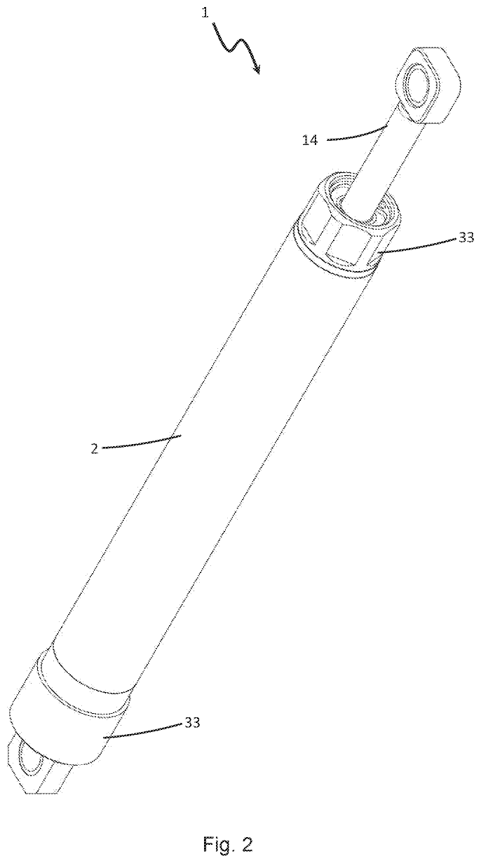

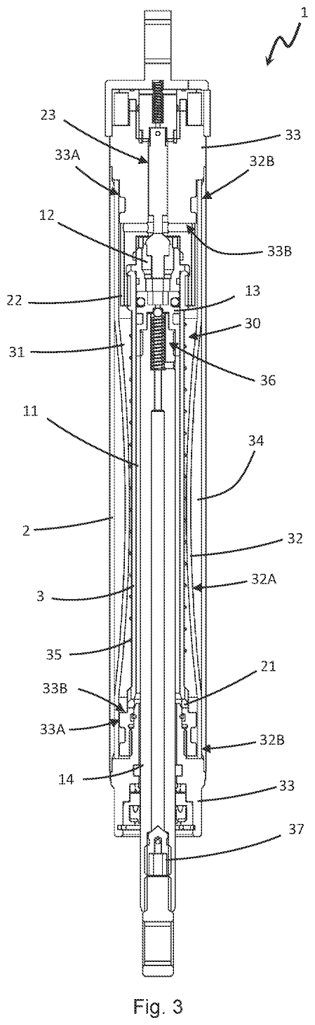

FIG. 2 shows a perspective view of a hydraulic cylinder 1 according to the invention. The hydraulic cylinder 1 comprises a round or tubular outer housing 2. A retaining member 33 is disposed at each of the axial ends of the outer housing 2. In the embodiment shown, the retaining members 33 serve on the one hand as a closure of the outer housing 2, cf. also FIG. 3. It is also conceivable that the retaining members 33 are disposed completely inside the outer housing 2 and separate closures are provided at the axial ends of the inner housing 3 or the outer housing 2. In the embodiment shown, one of the retaining members 33 additionally serves to guide the movable piston rod 14, which extends out of the outer housing 2 through the retaining member 33.

A cross-section through the hydraulic cylinder 1 of FIG. 2 is shown in FIG. 3. As shown, the outer housing 2 and the inner housing 3 disposed therein are tubular. The first working chamber 21 and the second working chamber 22 are disposed within the inner housing 3.

The movable piston 13 is disposed between the first working chamber 21 and the second working chamber 22, to which is attached the piston rod 14 extending through the first working chamber 21. As shown, in this embodiment, the pressure relief valve 36 is disposed inside the piston 13, which opens when the set pressure in the second working chamber 22 is reached and, in the open state, connects the first working chamber 21 and the second working chamber 22 in such a way that hydraulic fluid can flow from the second working chamber 22 into the first working chamber 21. The piston rod 14 comprises the closable filling valve 37, which is connected to the first working chamber 11 via a line disposed in the piston rod 14.

The first working chamber 11 is connected to a pressure accumulator 30 via the first line arrangement 21 and the second working chamber 12 is connected to the pressure accumulator 30 via the second line arrangement 22.

The pressure accumulator 30 comprises a storage space 31 located between the inner housing 3 and the outer housing 2 and formed by a membrane 32, the inner housing 3, and two radial surfaces 33B of the two axially spaced retaining members 33. In the illustrated embodiment, the membrane 32 is arranged in a tubular shape around the inner housing 3 and has a fixed portion 32B at each axial end and an elastic portion 32A between the fixed portions 32B. The fixed portions 32B of the membrane 32 are fixedly disposed between the outer housing 2 and respective radial surfaces 33A of the retaining members 33.

A separation element 35 is disposed inside the storage space 31, which in the illustrated embodiment is configured as a helical spring. The separation element 35 prevents the membrane 32 from lying flat against the inner housing 3 and adhering to it, which would impair the function of the hydraulic cylinder.

Between the outer housing 2 and the membrane 32, a preloading element 34 is further arranged, which in the embodiment example of FIG. 2 is configured as a space filled with compressed air. It is also conceivable that the membrane 32 is preloaded by a gas-filled space, a spring, a compressible silicone oil or a foam as preloading element 34. A combination of several preloading elements is also conceivable as preloading element 34. The preloading element 34 thereby presses the membrane 32 in the direction of the inner housing 3, whereby a pressure is made available in the storage space 31, as well as via the first line arrangement 21 and the second line arrangement 22 consequently also in the first working chamber 11 and in the second working chamber 12.

Due to the arrangement of the piston rod 14 in the first working chamber 11, the first working chamber 11 has a smaller volume for hydraulic fluid than the second working chamber 12. This difference in volume between the first working chamber 11 and the second working chamber 12 is compensated for by the storage space 31 of the pressure accumulator 30, in that the storage space 31 changes volume depending on the position of the piston 13 by absorbing the differential volume. The storage space 31 and the preloading element 34 interact in such a way that when the volume of the storage space 31 increases, the preloading element 34 is compressed by the elastically deforming membrane 32, and when the volume of the storage space 31 decreases, the preloading element 34 expands, thereby moving the membrane 32 in the direction of the inner housing 3.

The shut-off valve 23 is disposed between the second working chamber 12 and the pressure accumulator 30 within the second line arrangement 22. As mentioned, the shut-off valve 23 in the embodiment shown is configured as an electromagnetically actuated check shut-off valve. In the illustrated shut-off position of the shut-off valve 23, the hydraulic flow from the second working chamber 12 via the line arrangement 22 into the pressure accumulator 30 is blocked, preventing the piston rod 14 from retracting. Hydraulic flow from the pressure accumulator 30 via the second line arrangement 22 into the second working chamber 12, on the other hand, is continuously possible due to the check function of the shut-off valve 23, whereby extension of the piston rod 14 is possible at any time.

It is conceivable that, depending on the intended use of the hydraulic cylinder, the shut-off valve 23 may also be provided in a reverse arrangement so that retraction of the piston rod 14 is possible at any time and extension of the piston rod 14 is not possible when the shut-off valve 23 is in the shut-off position. Furthermore, it is conceivable that instead of a switchable shut-off valve, another form of switchable shut-off valve 23 is provided, for example a seat valve with a bypass line bypassing the seat with a check valve arranged therein.

### REFERENCE NUMERALS

1 hydraulic cylinder
2 outer housing
3 inner housing
11 first working chamber
12 second working chamber
13 piston
14 piston rod
21 first line arrangement
22 second line arrangement
23 shut-off valve
30 pressure accumulator
31 storage space
32 membrane
32A elastic portion
32B fixed portion
33 retaining element
33A radial surface
33B axial surface
34 preloading element
35 separation element
36 pressure relief valve
37 filling valve

1. A hydraulic cylinder for a restraint system comprising:
an outer housing;
an inner housing;
a pressure accumulator; and
a shut-off valve switchable between a release position and a shut-off position,
wherein the inner housing is disposed inside the outer housing, and
wherein the inner housing comprises a piston, a first working chamber and a second working chamber separated from the first working chamber by the piston,
wherein the first working chamber is connected to the pressure accumulator via a first line arrangement and the second working chamber is connected to the pressure accumulator via a second line arrangement,
wherein the pressure accumulator comprises a storage space for hydraulic fluid, and
wherein the shut-off valve is disposed in the second line arrangement and blocks the second line arrangement in the shut-off position,
wherein the pressure accumulator is disposed between the outer housing and the inner housing.

2. A hydraulic cylinder according to claim 1, wherein the storage space is at least formed by the inner housing and an at least partially elastic membrane.

3. A hydraulic cylinder according to claim 2, wherein the membrane is arranged around the inner housing.

4. A hydraulic cylinder according to claim 2, wherein the membrane comprises at least one elastic portion and at least one fixed portion.

5. A hydraulic cylinder according to claim 4, wherein the hydraulic cylinder comprises at least one retaining member, and wherein the at least one fixed portion is disposed between a radial surface of at least one retaining member and the outer housing.

6. A hydraulic cylinder according to claim 5, wherein the storage space is additionally formed by an axial surface of the at least one retaining member.

7. A hydraulic cylinder according to claim 5, wherein the at least one retaining member is arranged around the inner housing.

8. A hydraulic cylinder according to claim 2, wherein a preloading element preloads the membrane so that a pressure is provided in the storage space.

9. A hydraulic cylinder according to claim 8, wherein the preloading element is disposed between the membrane and the outer housing.

10. A hydraulic cylinder according to claim 8, wherein the preloading element comprises a spring, a foam, an elastic silicone oil and/or a space filled with compressed air.

11. A hydraulic cylinder according to claim 1, wherein a separation element is disposed in the storage space.

12. A hydraulic cylinder according to claim 11, wherein the separation element is arranged around the inner housing.

13. A hydraulic cylinder according to claim 11, wherein the separation element is a coil spring.

14. A hydraulic cylinder according to claim 11, wherein the separation element is provided on the inner housing.

15. A hydraulic cylinder according to claim 1, wherein a pressure relief valve is disposed between the first working chamber and the second working chamber.

16. A restraint system with a hydraulic cylinder according to claim 1.
